(19) United States
(12) Patent Application Publication
(10) Pub. No.: US 2009/0157774 A1
(43) Pub. Date: Jun. 18, 2009

(54) CHARACTER PATTERN-BASED FILE STORAGE TOOL

(75) Inventor: Cristiana D'Amore, Rome (IT)

Correspondence Address: IBM CORP. (AUSTIN), C/O NELSON AND NELSON, 2984 E. EVERGREEN AVE., SALT LAKE CITY, UT, 84109, US

(73) Assignee: INTERNATIONAL BUSINESS MACHINES CORPORATION, Armonk, NY (US)

(21) Appl. No.: 12/328,949

(22) Filed: Dec. 5, 2008

(30) Foreign Application Priority Data
Dec. 18, 2007 (EP) EP07301694

(51) Int. Cl. G06F 12/00; G06F 12/02; G06F 12/16

(52) U.S. Cl. 707/204; 707/205; 707/E17.01; 707/E17.044; 711/E12.001; 711/E12.002; 711/E12.103

(57) ABSTRACT

A method for selecting a storage path in a file system is presented. The method may provide a matching table to correlate a character pattern with at least one storage path in a file system. A file name including one or more character patterns may be received and the character pattern may be identified. The character pattern may then be correlated with the storage path according to the matching table. Finally, the storage path may be selected to store a file associated with the file name.

### BACKGROUND

As computer file quantities and usage increase, methods to facilitate file system management and navigation are needed. Storing a new file on an existing computer file system is often cumbersome, requiring the user to designate one of numerous storage paths for file storage. In some cases, shortcuts may be presented to a user to direct file storage towards a predefined path based on historical usage, for example. A user that wishes to group files categorically or topically, however, must sort through myriad storage location options to locate an appropriate storage path.

### SUMMARY

Embodiments of the invention have been developed to facilitate file system management and navigation by selecting a file storage path based on a recognized character pattern.

In one embodiment, a method for selecting a storage path in a file system may include providing a matching table to correlate a character pattern with at least one storage path in a file system. A file name including one or more character patterns may be received and the character pattern may be identified. The character pattern may then be correlated with the storage path according to the matching table. Finally, the storage path may be selected to store a file associated with the file name.

A corresponding apparatus and computer program product are also disclosed and claimed herein.

### BRIEF DESCRIPTION OF THE DRAWINGS

In order that the advantages of the disclosure will be readily understood, a more particular description of embodiments of the invention briefly described above will be rendered by reference to specific embodiments illustrated in the appended drawings. Understanding that these drawings depict only typical embodiments of the invention and are not therefore to be considered limiting of its scope, embodiments of the invention will be described and explained with additional specificity and detail through use of the accompanying drawings, in which:

FIG. 1 depicts a system implementing an embodiment of the invention;

FIG. 2 depicts a data model showing relationships between different components of embodiments of the invention; and

FIG. 3 shows a high-level process for saving a file at a given path in accordance with embodiments of the invention.

### DETAILED DESCRIPTION OF THE INVENTION

It will be readily understood that the components of embodiments of the present invention, as generally described and illustrated in the Figures herein, may be arranged and designed in a wide variety of different configurations. Thus, the following more detailed description of the embodiments of the systems and methods of the present invention, as represented in the Figures, is not intended to limit the scope of the disclosure, as claimed, but is merely representative of selected embodiments of the invention.

Reference throughout this specification to “one embodiment,” “an embodiment,” or similar language means that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that embodiments of the invention can be practiced without one or more of the specific details, or with other methods, components, etc. In other instances, well-known structures, or operations are not shown or described in detail to avoid obscuring aspects of the disclosure.

The illustrated embodiments of the invention will be best understood by reference to the drawings, wherein like parts are designated by like numerals throughout. The following description is intended only by way of example, and simply illustrates certain selected embodiments of the invention that are consistent with the disclosure as claimed herein.

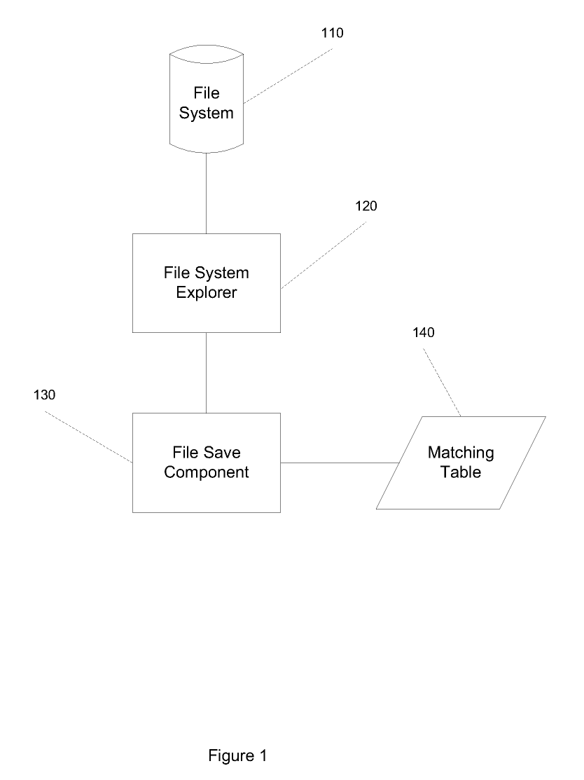

FIG. 1 shows a system implementing the present invention, including a file system 110, a file system explorer 120, a file save component 130, and a matching table 140. The file system 110 may organize the information on a permanent storage medium, such as tapes or hard disks, to make it easily accessible while taking into account various constraints, such as security or compression. The file system explorer 120 may provide an interface to interact with the file system 110. Particularly, the file system explorer 129 may retrieve, create or delete files on the file system 110.

The file save component 130 may interact with the file system explorer 120 to save a file on the file system. The file save component 130 may provide as inputs to the file system explorer 120 a file name, a pointer towards an address in memory where the file content is stored, and a path indicating where in the file system 110 the file should be stored. This information may be contained in a table. In one embodiment, for example, the table may be a matching table 140.

The matching table 140 may include at least two columns. The first column may contain file name patterns, and the second column may contain file storage paths. Associating a name pattern with a path at a given row in the matching table may allow the file save component 130 to preselect a path in the matching table 140 upon submission of a file name containing a known file name character pattern. Optionally, the matching table 140 may contain several paths for a given character pattern, enabling the file save component 130 to store several copies of the file at the various locations represented by the different paths.

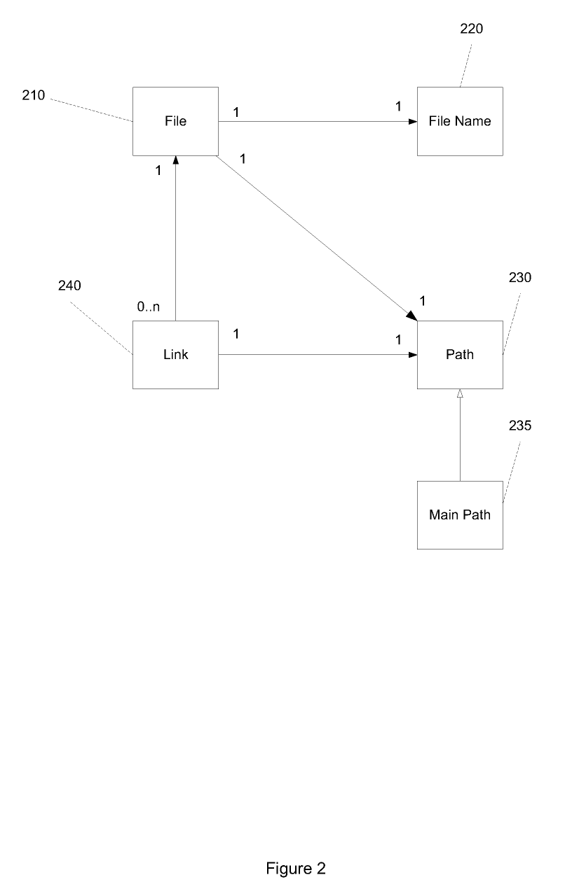

When a character pattern may be associated with several paths, the matching table 140 may include a third column to identify a particular path as the main path. This may allow the file save component 130 to store the file at the main path only once. The file save component 130 may then create links at locations represented by the paths associated with the character pattern and not marked as the main path. These interrelationships between a file, links and path are described in more detail with respect to FIG. 2 below.

A character pattern may be represented in various ways. For example, the character pattern may include a simple string of authorized characters in a path representing a location in a standard file system. In this case, any file name containing the string of characters (such as .jpg) may be associated with the corresponding path in the matching table 140.

In other embodiments, the character pattern may be more complex. For example, the character pattern may resemble a character pattern that may be provided to a search engine, such as a regular expression. For instance, a question mark may indicate that there is zero or one of the preceding element. An asterisk may indicate that there are zero or more of the preceding element. The plus sign may indicate that there is one or more of the preceding element. Different types of regular expression syntax, such as UNIX regular expressions or POSIX regular expressions, may be used.

Referring now to FIG. 2, a data model may be used to represent relationships between different components of embodiments of the present invention. Such components may include, for example, a file 210, a file name 220, a storage path 230, a main path 235, and a link 240.

A file 210 may be associated with one file name 220, one path 230, which may be identified as a main path 235, and any number of links 240 which may point towards the file 210. In one embodiment, a link 340 may be located at a path 230 in the file system.

Traditional file systems often include a static file structure where files are located at one particular path. File systems with a more relational approach may allow one file to be associated with several different paths. The teachings of the present invention may be easily applied in this case.

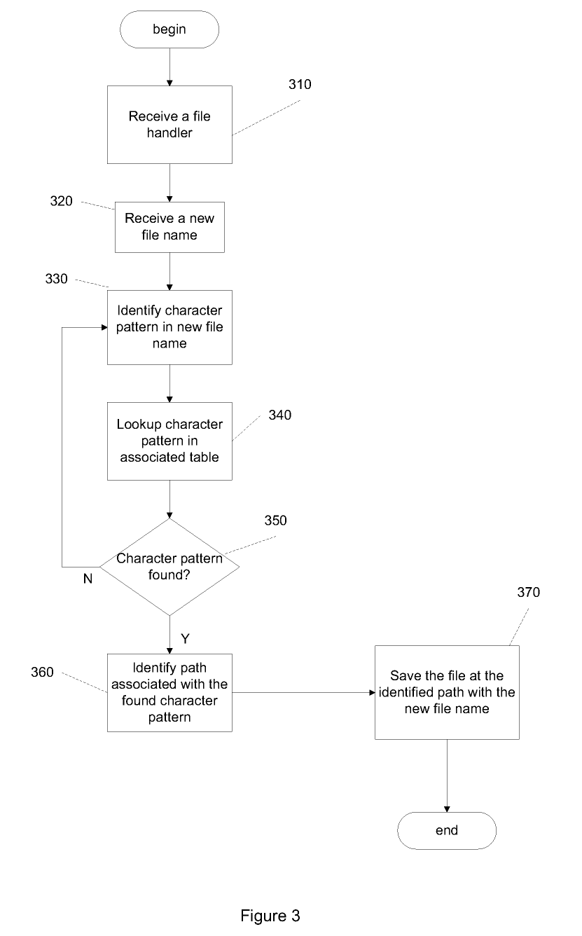

Referring now to FIG. 3, a high-level process for storing a file in accordance with embodiments of the present invention may include receiving a file handler 310, receiving a new file name 320, and identifying a character pattern in the new file name 330. The process may further include looking up the character pattern in a table 340 and deciding whether the character pattern is found 350. If the character pattern is not found, a new character pattern may be identified 330. If the character pattern is found, a path associated with the found character pattern may be identified 360, and the file may be saved with the new file name at the identified path location 370.

This process may allow a user to select an appropriate path in a folder structure to store the file at a predefined path location 370. The associated table used for this purpose may be the matching table described above with respect to FIG. 1.

In the case of a plurality of paths associated with the character pattern, the step 370 of saving the file may further include the step of saving a copy of the file at each path location identified in step 360. If one path among the identified paths is marked as a main path, then only one copy of the file may be stored at the main path location. Links pointing towards the file may be created at the other path locations.

In another embodiment, a method for storing a file 210 at a predefined path location 230, the path location 230 may be first associated with a particular character pattern. The character pattern may then be detected in the name 220 of the file to store.

The invention can take the form of an entirely hardware embodiment, an entirely software embodiment or an embodiment containing both hardware and software elements. In one embodiment, the invention is implemented in software, which includes but is not limited to firmware, resident software, microcode, etc.

Furthermore, the invention may take the form of a computer program product accessible from a computer-usable or computer-readable medium providing program code for use by or in connection with a computer or any instruction execution system. For the purposes of this description, a computer-usable or computer readable medium can be any apparatus that may contain, store, communicate, propagate, or transport the program for use by or in connection with the instruction execution system, apparatus, or device.

The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code may include at least one processor coupled directly or indirectly to memory elements through a system bus. The memory elements may include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) may be coupled to the system either directly, or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

1. A method for selecting a storage path in a file system, the method comprising:
providing a matching table to correlate a character pattern with at least one storage path in a file system;
receiving a file name comprising at least one character pattern;
identifying the character pattern;
correlating the character pattern with the at least one storage path according to the matching table; and
selecting the at least one storage path to store a file associated with the file name.

2. The method of claim 1, wherein a first column of the matching table comprises a list of character patterns and a second column of the matching table comprises a list of storage paths.

3. The method of claim 1, wherein the character pattern satisfies a POSIX regular expression.

4. The method of claim 1, wherein at least two storage paths correlate to the character pattern.

5. The method of claim 4, further comprising:
receiving a handler towards the file associated with the file name; and
storing a copy of the file at locations corresponding to each of the at least two storage paths.

6. The method of claim 4, wherein one of the at least two storage paths is identified as a main path.

7. The method of claim 6, further comprising:
receiving a handler towards the file;
storing the file at a location corresponding to the main path; and
creating a link corresponding to the file at the storage paths other than the main path.

8. An apparatus for selecting a storage path in a file system, the apparatus comprising:
a file system to provide a matching table to correlate a character pattern with at least one storage path in a file system;
a file system explorer to receive a file name comprising at least one character pattern; and
a file save component to identify the character pattern, correlate the character pattern with the at least one storage path according to the matching table, and select the at least one storage path to store a file associated with the file name.

9. The apparatus of claim 8, wherein a first column of the matching table comprises a list of character patterns and a second column of the matching table comprises a list of storage paths.

10. The apparatus of claim 8, wherein the character pattern satisfies a POSIX regular expression.

11. The apparatus of claim 8, wherein at least two storage paths are associated with the character pattern.

12. The apparatus of claim 11, wherein the file save component further receives a handler towards the file associated with the file name and stores a copy of the file at locations corresponding to each of the at least two storage paths.

13. The apparatus of claim 11, wherein one of the at least two storage paths is identified as a main path.

14. The apparatus of claim 13, wherein the file save component further receives a handler towards the file and stores the file at a location corresponding to the main path.

15. The apparatus of claim 14, wherein the file save component further creates a link corresponding to the file at the storage paths other than the main path.

16. A computer program product for selecting a storage path in a file system, the computer program product comprising:
a computer-usable medium having computer-usable program code embodied therein, the computer-usable program code comprising:
computer-usable program code for providing a matching table to correlate a character pattern with at least one storage path in a file system;
computer-usable program code for receiving a file name comprising at least one character pattern;
computer-usable program code for identifying the character pattern;
computer-usable program code for correlating the character pattern with the at least one storage path according to the matching table; and
computer-usable program code for selecting the at least one storage path to store a file associated with the file name.

17. The computer program product of claim 16, wherein at least two storage paths correlate to the character pattern.

18. The computer program product of claim 17, further comprising:
computer-usable program code for receiving a handler towards the file associated with the file name; and
computer-usable program code for storing a copy of the file at locations corresponding to each of the at least two storage paths.

19. The computer program product of claim 17, wherein one of the at least two storage paths is identified as a main path.

20. The computer program product of claim 19, further comprising:
computer-usable program code for receiving a handler towards the file;
computer-usable program code for storing the file at a location corresponding to the main path; and
computer-usable program code for creating a link corresponding to the file at the storage paths other than the main path.
